(19) United States
(12) Patent Application Publication
(10) Pub. No.: US 2011/0253803 A1
(43) Pub. Date: Oct. 20, 2011

(54) STEAM SPRAYING DEVICE

(76) Inventor: Bennett Kennedy, Oakboro, NC (US)

(21) Appl. No.: 12/967,161

(22) Filed: Dec. 14, 2010

Related U.S. Application Data
(63) Continuation-in-part of application No. 12/761,790, filed on Apr. 16, 2010.

(51) Int. Cl. B67D 7/08; B05B 15/00; B05B 1/24

(52) U.S. Cl. 239/71; 239/136; 239/375

(57) ABSTRACT

A steam spraying device that includes a handle having a hollow inner cavity and a body including a right shell and a left shell that has an interior void for receiving a container containing liquid. A pump is disposed within the interior void of the body, and a steam generation chamber for producing steam. A spray nozzle for dispensing the steam is disposed on the exterior of the body. The spraying device optionally includes a hood over the spray nozzle for limiting over spray.

The present non-provisional patent application is a continuation-in-part of co-pending U.S. patent application Ser. No. 12/761,790, filed on Apr. 16, 2010, and entitled “Spraying Device.”

### FIELD OF THE INVENTION

The present invention relates generally to a steam spraying device and more generally relates to a steam spraying device that concentrates the steam on a desired plant or weed, resulting in the extermination of the plant or weed without the use of harmful herbicides.

### BACKGROUND OF THE INVENTION

Sprayers have been used for many years to deliver herbicide to a plant or a weed. These sprayers are able to spray large swatches of plants or weeds in order to coat them with the herbicide. Unfortunately, these spraying devices spray large amounts of herbicide that go unused, or worse, contact plants or grasses that are not intended to be sprayed. These spraying devices waste large amounts of herbicides, resulting in an increase in the amount of herbicide that need to be purchased. On the other hand, a herbicide may only be intended for spraying an intended weed, but because of the total inaccuracy of the spraying device, an expensive plant is unintentionally coated with the herbicide, resulting in the death of the plant. Additionally, the herbicide could be harmful to the environment.

The steam spraying device disclosed in the present invention allows utilizes steam, instead of a herbicide, to exterminate a weed or plant, which is more environmentally friendly.

### BRIEF SUMMARY OF THE INVENTION

One embodiment of the present invention includes a handle and a body including a right shell and left shell having an interior void for receiving a container containing liquid. A pump is disposed within the interior void of the right shell and the left shell. A steam generation chamber is disposed within the interior void of the right shell and the left shell for producing steam, and a spray nozzle is disposed on the body for dispensing steam.

According to another embodiment of the present invention, a steam spraying device that includes a switch for activating the pump.

According to yet another embodiment of the present invention, a steam spraying device that includes a hood positioned around the spray nozzle.

According to yet another embodiment of the present invention, a steam spraying device that includes a handle having a hollow inner cavity and at least one battery positioned within the hollow inner cavity of the handle.

According to yet another embodiment of the present invention, a steam spraying device that includes a container mount having inner threads for receiving a correspondingly threaded container and engaging the container mount and the container in a selectively secured arrangement, wherein the container mount further includes a gasket disposed between the container and container mount.

According to yet another embodiment of the present invention, a steam spraying device that includes a power cable for supplying power to the steam spraying device.

According to yet another embodiment of the present invention, a steam spraying device that includes a ready light for indicating when steam has been generated by the steam generation device.

According to yet another embodiment of the present invention, a steam spraying device that includes a handle having a hollow inner cavity, and a body comprising a right shell and a left shell that are selectively secured to each other forming an interior void for receiving a container containing liquid. A pump is disposed within the interior void of the right shell and the left shell. A steam generation chamber that is disposed within the interior void of the right shell and the left shell for generating steam. A switch is disposed on the handle for activating the pump, and a spray nozzle for dispensing the steam.

According to yet another embodiment of the present invention, a steam spraying device that includes a switch that is engaged to an electrical wire and the electrical wire is engaged to the power source.

According to yet another embodiment of the present invention, steam a spraying device that includes a handle having a hollow inner cavity, and a body comprising a right shell and a left shell that are selectively secured to each other forming an interior void. A container mount is disposed within the interior void for receiving a container of liquid that comprises a gasket and an aspirator valve, wherein the gasket prevents leakage from the container when engaged to the container mount and the aspirator valve permits air to pass into the container. A pump is disposed within the interior void of the right shell and the left shell. A motor is disposed within the interior void of the right shell and the left shell for operating the pump, and at least one battery positioned within the hollow inner cavity of the handle for supplying power to the motor. A switch is disposed on the handle for activating and deactivating the supply of power to the motor. A spray nozzle for dispensing the liquid is contained within the container.

According to yet another embodiment of the present invention, the steam spraying device includes at least one battery that is at least a rechargeable battery positioned within the hollow inner cavity of the handle.

According to yet another embodiment of the present invention, the steam spraying device includes a power thermostat for regulating the temperature in the steam generation chamber.

### BRIEF DESCRIPTION OF THE DRAWINGS

The present invention is illustrated and described herein with reference to the various drawings, in which like reference numbers denote like system components, respectively, and in which:

FIG. 1 is a perspective view of the steam spraying device;

FIG. 2 is an exploded view of the steam spraying device of FIG. 1;

FIG. 3 is a cross-sectional view of the steam spraying device of FIG. 1;

FIG. 4 is a perspective view of the steam spraying device in use;

FIG. 5 is a perspective view of the hydraulic parts of the steam spraying device;

FIG. 6 is a cross-sectional view of the exit check valve and entrance check valve of the steam spraying device;

FIG. 7 is a cross-sectional view of the bottle mount of the steam spraying device;

FIG. 8 is a perspective view of the electrical components of the steam spraying device;

FIG. 9 is a schematic diagram of the electrical and hydraulic parts of the steam spraying device;

FIG. 10 is a perspective view of another embodiment of the steam spraying device;

FIG. 11 is an exploded view of the steam spraying device of FIG. 10;

FIG. 12 is a perspective view the charger and upper portion of the steam spraying device; and

FIG. 13 is a schematic diagram of the electrical and hydraulic parts of the steam spraying device.

### DETAILED DESCRIPTION OF THE INVENTION

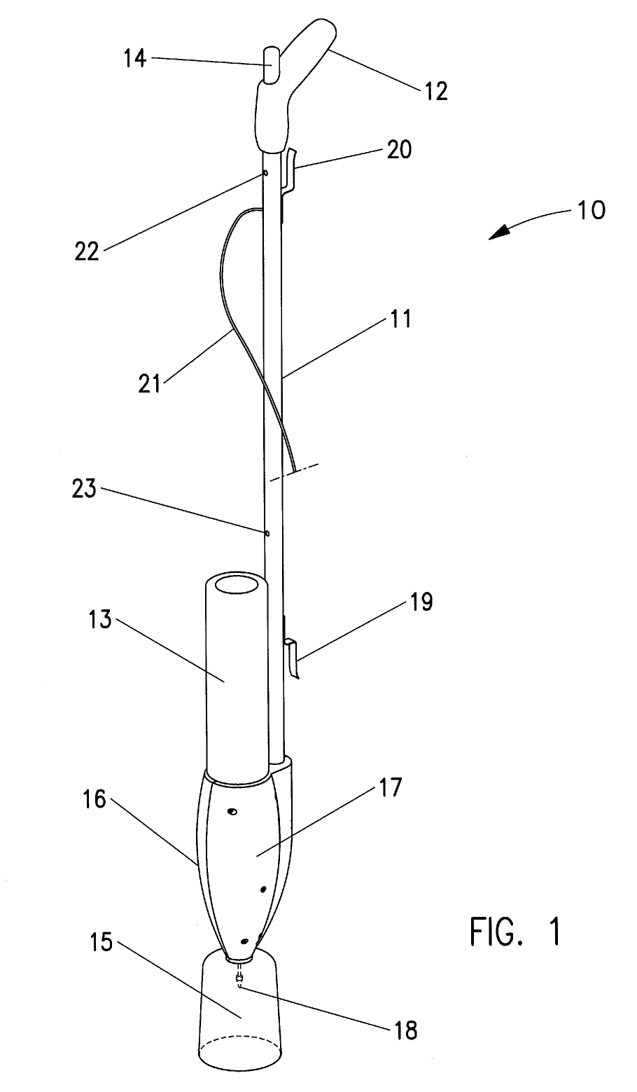

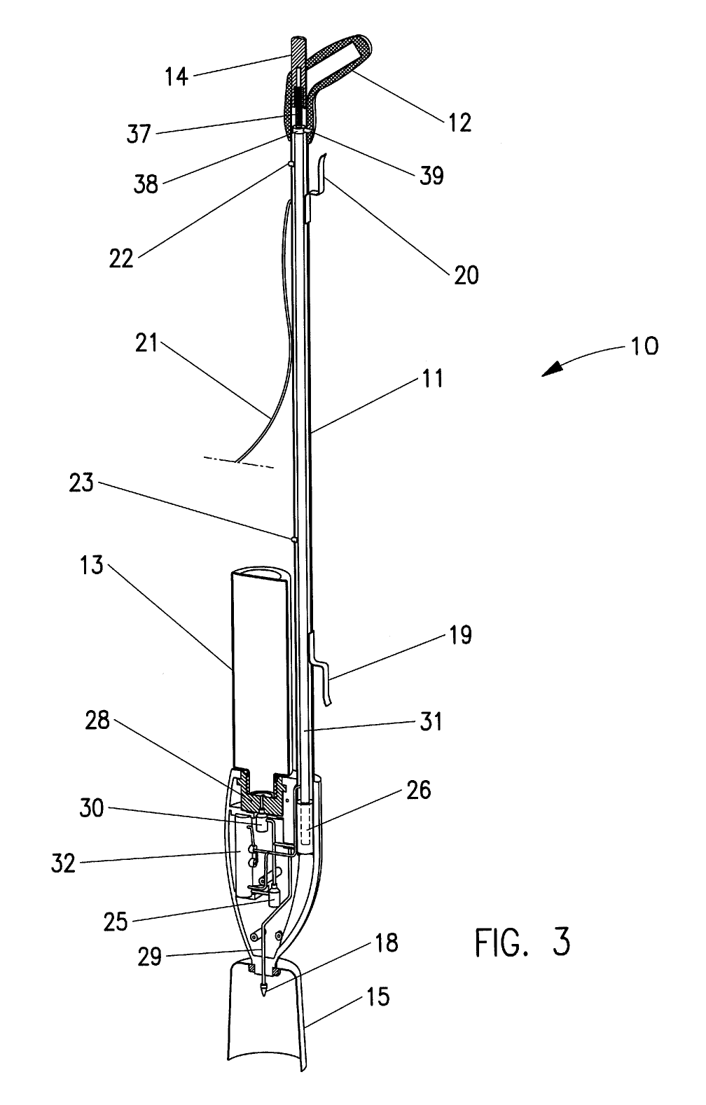

Referring now specifically to the drawings, an exemplary sprayer is illustrated in FIGS. 1, 2, 3, and 4 and is shown generally at reference numeral 10. The sprayer 10 includes a handle 11, a handle grip 12, hood 15 with a spray nozzle 18 positioned inside, and a body comprising a right shell 16 and a left shell 17. The hood 15 is held between the right shell 16 and a left shell 17 forming an interior void therein. A container 13 is positioned within the right shell 16 and left shell 17. The handle 11 is fastened onto the right shell 16 and left shell 17 and is provided with a handle grip 12 on its upper end. The handle grip 12 is equipped with an injector button 14 to activate the sprayer 10.

A power cable 21 is used to provide power to the sprayer 10. One end of the power cable 21 is disposed on the sprayer 10 and the other end of the power cable 21 may be inserted into an external power source, such as a standard electrical outlet. A lower power cable hook 19 and an upper power cable hook 20 are disposed on the handle 11 for storing the power cable 21, when the power cable 21 is not in use. A ready light 22 is disposed on the handle and illuminates when the sprayer 10 is hot enough for the generation of steam. Additionally, a power light 23 is disposed on the handle and illuminates when the power cable 21 is inserted into an external power source.

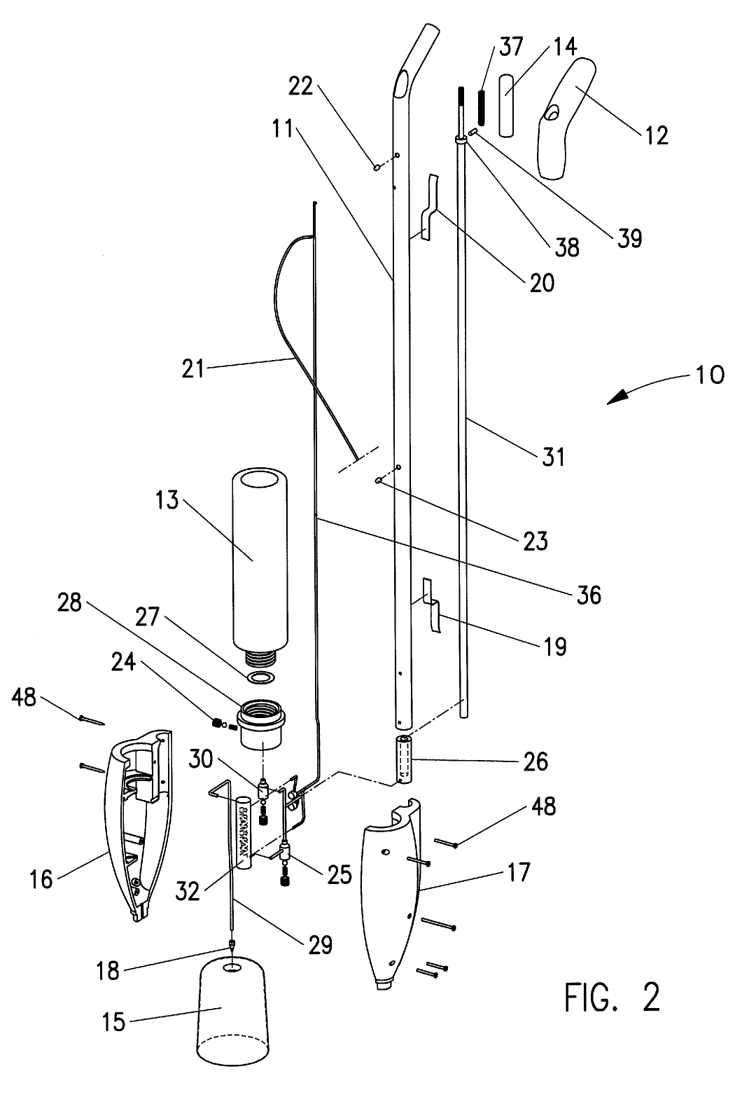

As illustrated in FIG. 2, the hood 15 on the bottom portion of the sprayer 10 serves to protect neighboring plants from the steam spray. It is preferably made from a transparent material, such as plastic or the like. The spray nozzle 18 is positioned within the hood 15 and is mounted on a steam tube 29 which in turn is mounted on the exit side of a steam chamber 32.

The right shell 16 and left shell 17 enclose an exit check valve 25, an entrance check valve 30, and a bottle mount 28 containing an aspirator valve 24. The right shell 16 and left shall 17 are selectively secured to one another by screw fasteners 48. During use, a bottle 13, containing water for steam generation, is engaged to the bottle mount 28. Preferably, the bottle 13 contains threads and the bottle mount 28 contains corresponding threads for receiving the threads of the bottle 13 forming a selectively secured arrangement. A gasket 27 may be used to seal the junction between the bottle 13 and bottle mount 28.

An injector pump 26 is also enclosed within the right shell 16 and left shell 17. As shown in FIG. 2, the injector pump 26 may fit inside the handle 11, which is a hollow tubular handle 11. The injector pump 26 is positioned within hollow portion of the lower portion of the handle 11, and the lower portion of the handle 11 is enclosed by the right shell 16 and left shell 17. An injector rod 31 having a first end and a second end, wherein the second end may be engaged to the injector pump 26 and acts as a displacement cylinder to inject liquid into the steam chamber 32. The first end of the injector rod 31 is engaged to the injector button 14. The injector button 14 is positioned within the upper end of the handle 11. A handle grip 12 may be disposed on the upper end of the handle 11, whereby the injector button 14 protrudes through the handle grip 12 through an opening therein. The injector rod 31 is upwardly biased by means of an injector spring 37 that pushes against an injector collar 38. The injector collar 38 is engaged to the handle grip 12 by way of a screw set 39.

A wire harness 36 provides the requisite electrical connections for the steam sprayer 10. The electrical power to power the steam sprayer 10 is supplied by way of the power cable 21, which is inserted into a standard power source such as an electrical outlet. As the power cable 21 is inserted into the power source, the power light 23 is illuminated and the ready light 22 on the upper end of the handle 11 is illuminated when the steam chamber 32 is at a suitable temperature for steam generation. The power cable 21 may be conveniently stored on the lower cable hook 19 and upper cable hook 20, when not in use.

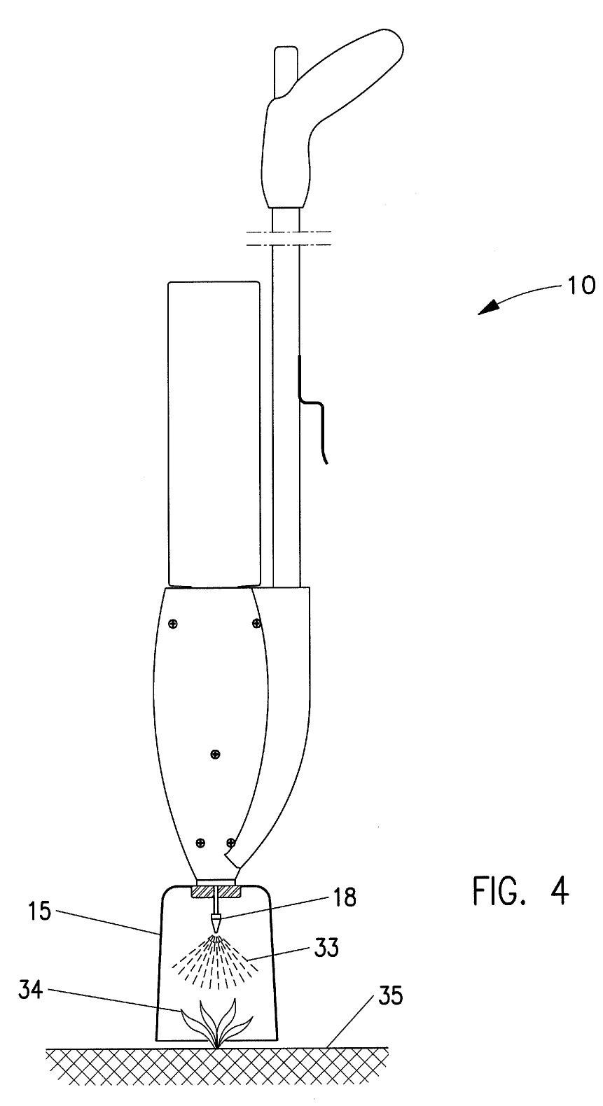

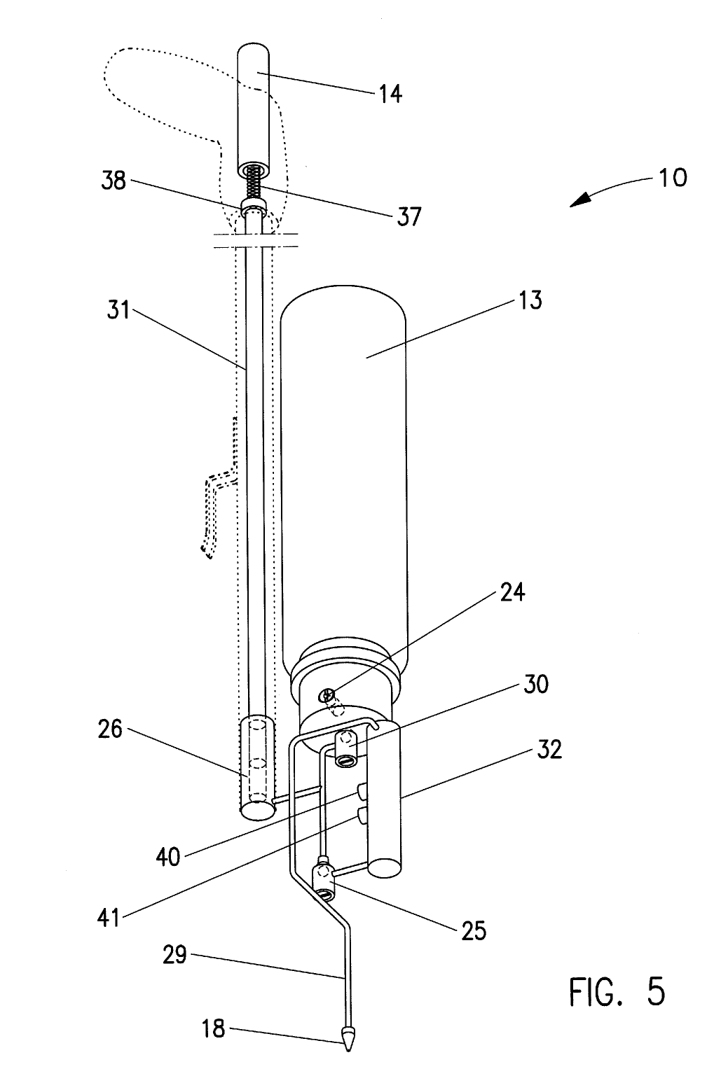

FIG. 5 illustrates the hydraulic parts of the steam sprayer 10. As mentioned above, water, which is used to generate the steam, is stored in the bottle 13. When the user depressors the injector button 14, the injector rod 31 to translates downward and into the injector pump 26. The water is then injected through the exit check valve 25 and into the steam chamber 32. The entrance check valve 30 prevents the water from backing up into the bottle 13. The water is then converted into steam in the steam chamber 32 and exits through the steam tube 29. Once the steam exits through the steam tube 29, the steam then progresses through the spray nozzle 18 and onto the weed 34 (as shown in FIG. 4). When the user releases the injector button 14, a vacuum is created in the injector pump 26, sucking water from the bottle 13 and through the entrance check valve 30 and into the injector pump 26. When the water is removed from the bottle 13, a void is created in the bottle 13, resulting in a partial vacuum. The vacuum pulls air into the bottle 13 through the air entrance 46.

A power thermostat 40 may be mounted to the side of the steam chamber 32, which switches the electric power off to the steam chamber 32 when the temperature has reached a predetermined level. The ready light 22 is illuminated by an indicator thermostat 41 when the temperature in the steam chamber 32 reaches a predetermined temperature sufficient for steam generation. Preferably, the predetermined temperature setting of the indicator thermostat 41 is lower than that of the power thermostat 40.

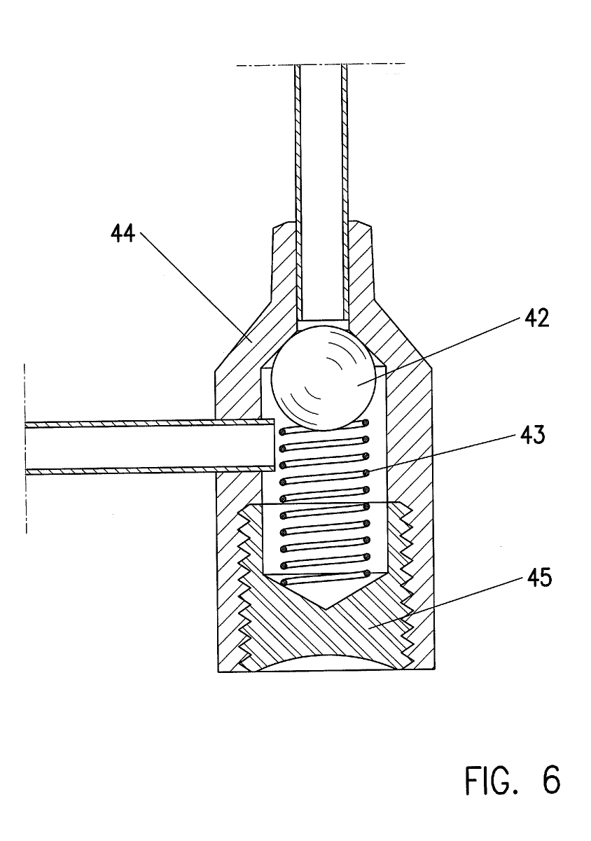

FIG. 6 illustrates the exit check valve 25 and entrance check valve 30 of the present invention. The check valves (25, 30) include a check ball 42, a check spring 43, a check housing 44, and a check plug 45.

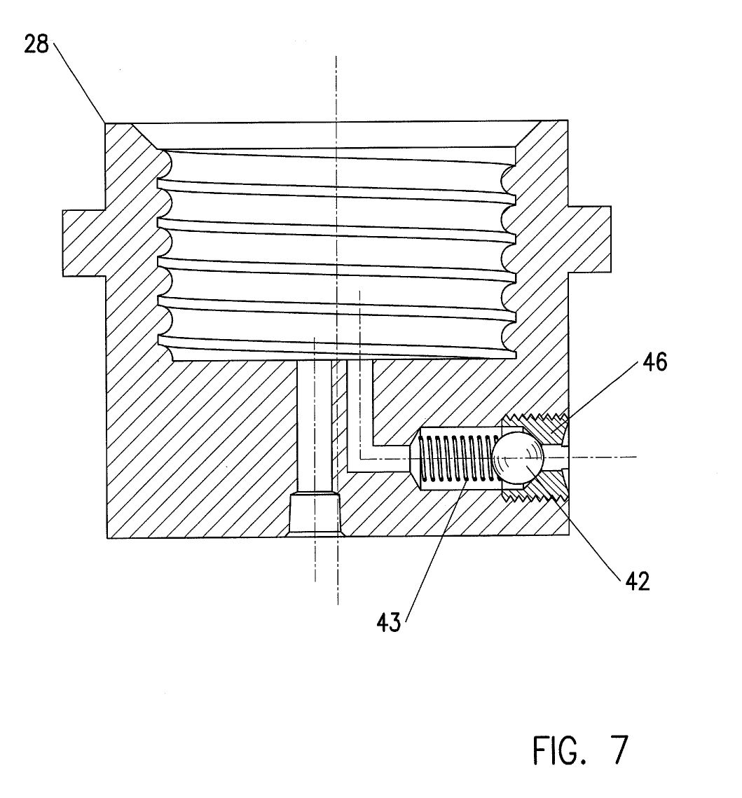

FIG. 7 illustrates the bottle mount 28. The bottle mount 28 includes a check ball 42, a check spring 43, and a check seat 46.

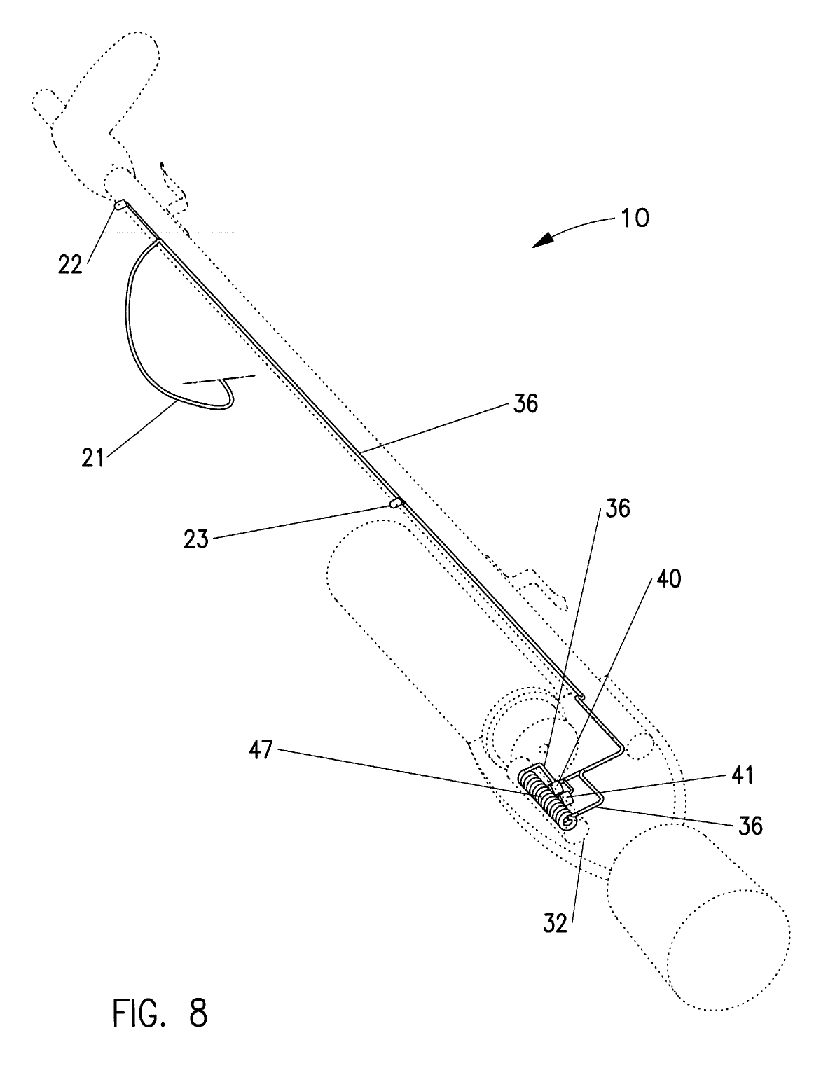

FIG. 8 illustrates the electrical components of the steam sprayer 10. The power cable 21 is connected to a standard electrical outlet for supplying power to the device 10. Once the power is supplied to the device 10, the ready light 22, on the upper end of the handle 11, is illuminated and power is supplied to the heating coil 47 across the power thermostat 40. When the temperature in the steam chamber 32 has reached a predetermined temperature sufficient to generate steam, the indicator thermostat 41 illuminates the ready light 22. If the steam chamber 32 temperature rises above a predetermined temperature, the power thermostat 40 ceases the flow of electricity to the heating coil 47, resulting in reduction in temperature of the heating coil 47. Once the temperature is lowered below a predetermined temperature, power thermostat 40 allows the flow of electricity and the heating coil 47 temperature rises.

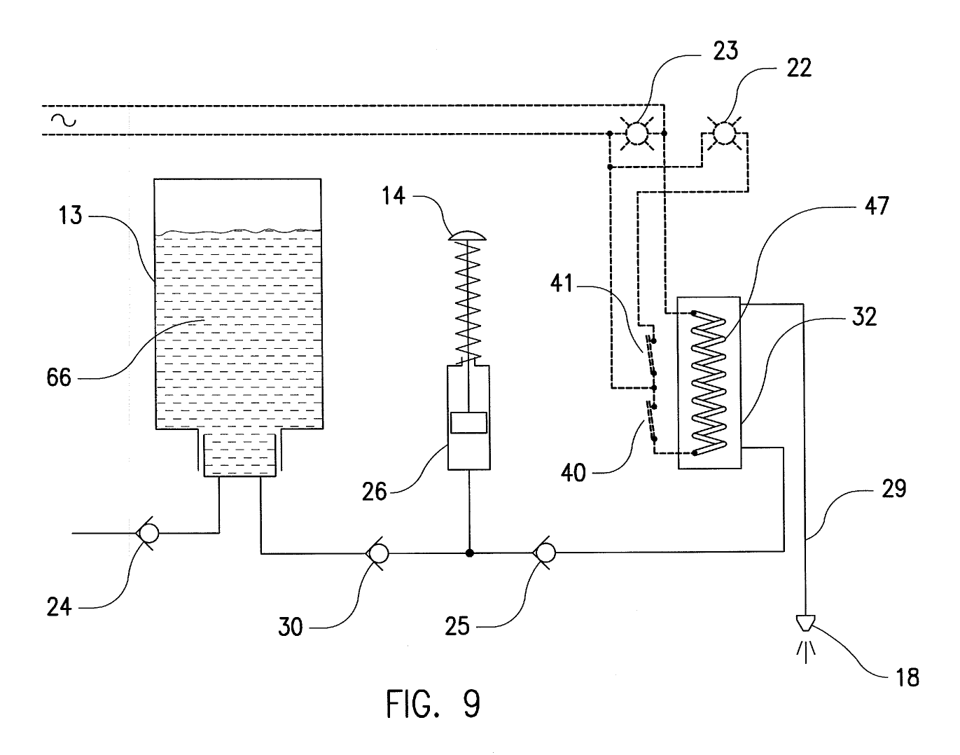

FIG. 9 illustrates the electrical components and the hydraulic parts of the steam sprayer 10. During use, the injector button 14 is depressed and water 66 enters through the exit check valve 25 and into the steam chamber 32. The water 66 is then heated by the heating coil 47, thus producing steam. The steam progresses through the steam tube 29 and the spray nozzle 18. As illustrated in FIG. 9, both the power thermostat 40 and indicator thermostat 41 are closed, indicating the steam chamber 32 is at a temperature sufficient to generate steam, but not at a temperature requiring the supply of power to be ceased to cool the steam chamber 32 to a predetermined temperature. The ready light 22 and the power light 23 are illuminated and indicate the steam sprayer 10 is connected to an electrical outlet. The release of the injector button 14 will suck water out of the bottle 13, through the entrance check valve 30 and into the injector pump 26.

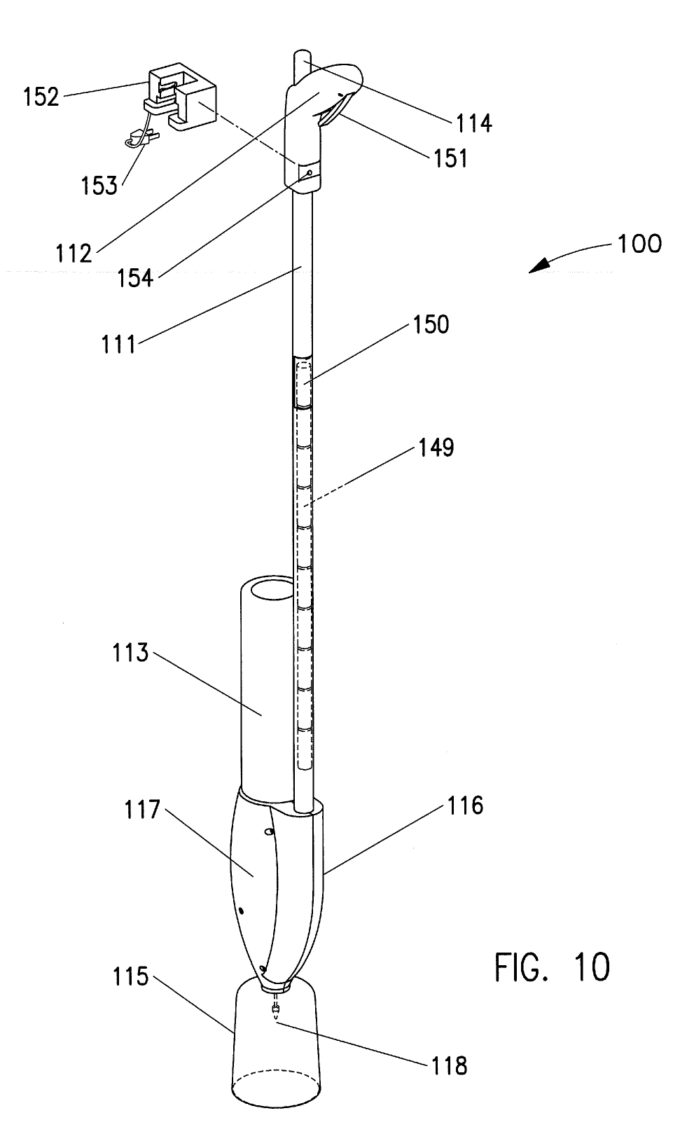

FIG. 10 illustrates another embodiment of the present invention. This illustrated embodiment is a cordless steam sprayer 100 that uses batteries 149 to supply the electrical power to the steam chamber 132. This embodiment includes a battery door 150 that may be removed to enable the insertion and removal of the batteries 149. The batteries may also be rechargeable. A charger 152 is provided with a power cord 153, whereby the power cord 153 is inserted into a standard electrical outlet. The steam sprayer 100 is then inserted into the charger 152 for charging.

The sprayer 100 includes a handle 111, a handle grip 112, hood 115 with a spray nozzle 118 positioned inside, and a body comprising a right shell 116 and a left shell 117. The hood 115 is held between the right shell 116 and a left shell 117 forming an interior void therein. A container 113 is positioned within the right shell 116 and left shell 117. The handle 111 is fastened onto the right shell 116 and left shell 117 and is provided with a handle grip 112 on its upper end. The handle grip 112 is equipped with an injector button 114 to activate the sprayer 110.

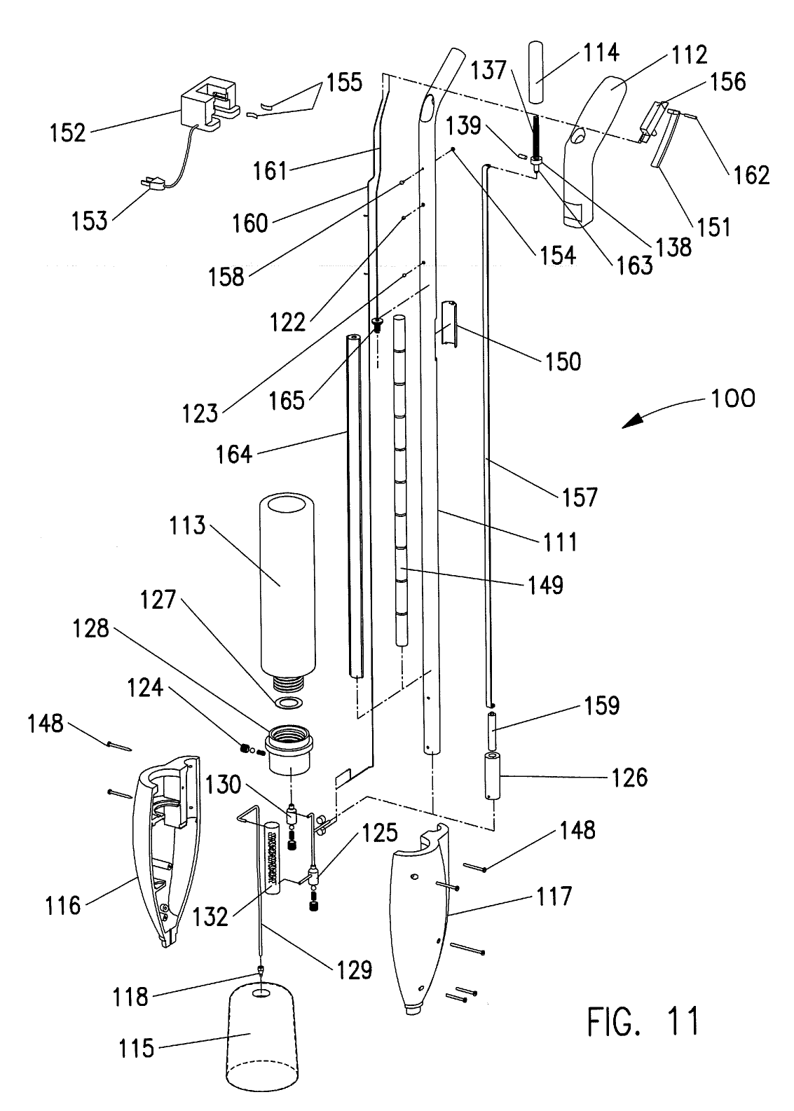

As illustrated in FIG. 11, the hood 115 on the bottom portion of the sprayer 100 serves to protect neighboring plants from the steam spray. It is preferably made from a transparent material, such as plastic or the like. The spray nozzle 118 is positioned within the hood 115 and is mounted on a steam tube 129 which in turn is mounted on the exit side of a steam chamber 132. An injector pump 126 is also enclosed within the right shell 116 and left shell 117, which are held together by screw fasteners 148. The right shell 116 and left shell 117 also enclose an exit check valve 125, an entrance check valve 130, a bottle mount 128, and an aspirator valve 124. The injector pump 126 may fit inside the handle 111, which is a hollow tubular handle 111. The injector pump 126 is positioned within hollow portion of the lower portion of the handle 111, and the lower portion of the handle 111 is enclosed by the right shell 116 and left shell 117. A piston 159 having a first end and a second end, wherein the second end may be engaged to the injector pump 126 and acts as a displacement cylinder to inject liquid into the steam chamber 132. The first end of the piston 159 is engaged to an injector bar 157 that is attached at its upper end to an injector shaft 163. The injector button 114 is positioned within the upper end of the handle 111. A handle grip 112 may be disposed on the upper end of the handle 111, whereby the injector button 114 protrudes through the handle grip 112 through an opening therein. The injector shaft 163 is upwardly biased by means of an injector spring 137 that pushes against an injector collar 138. The injector collar 138 is engaged to the handle grip 112 by way of a screw set 139.

The power wire 160 and the battery wire 161 provide the requisite electrical connections for the steam sprayer 100 when a switch lever 151 is manually depressed. The depressed switch lever 151 actuates a power switch 156 and completes the electrical circuit between the batteries 149 and the steam chamber 132. The power light 123 is illuminated when power is supplied, and the ready light 122 is illuminated when the steam chamber 132 reaches a predetermined temperature for generating steam.

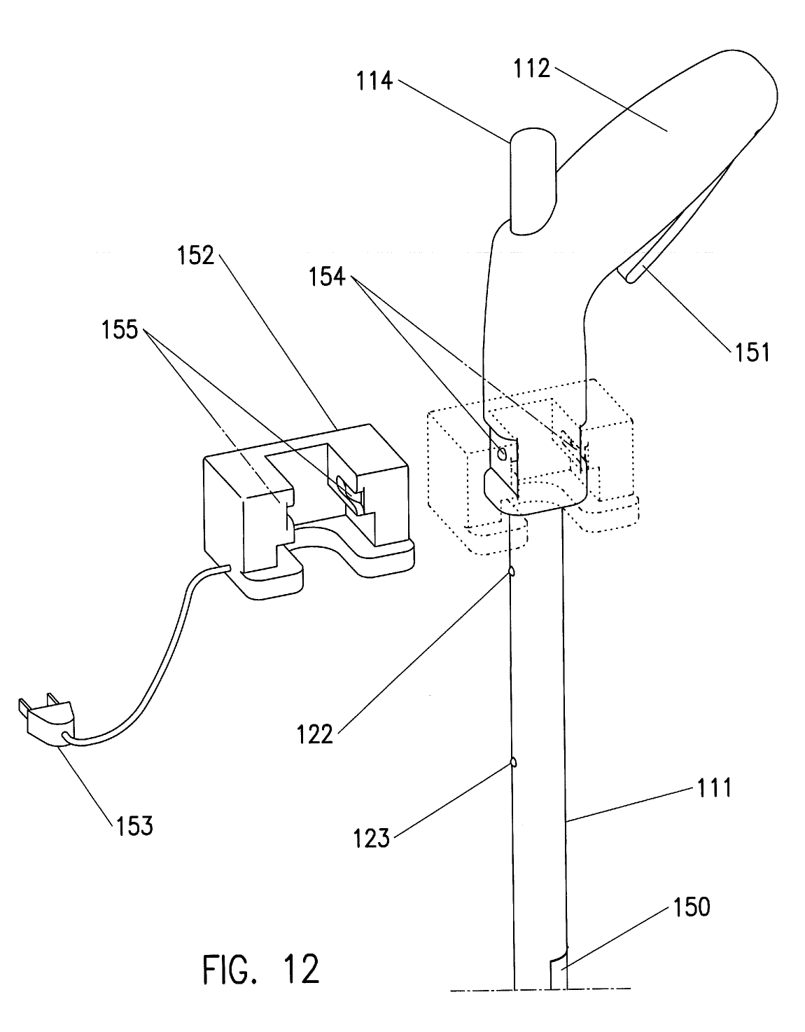

FIG. 12 illustrates the upper portion of the steam sprayer 100. The handle grip 112 is mounted on top of the handle 111. A switch lever 151 activates the electricity supplied by the batteries 149 by grabbing the handle 111 and depressing the switch lever 151. The charger 152 includes a power cord 153 that is inserted into a standard electrical outlet. Two conductive strips 155 are embedded into the charger 152 for making an electrical connection with the steam sprayer 110.

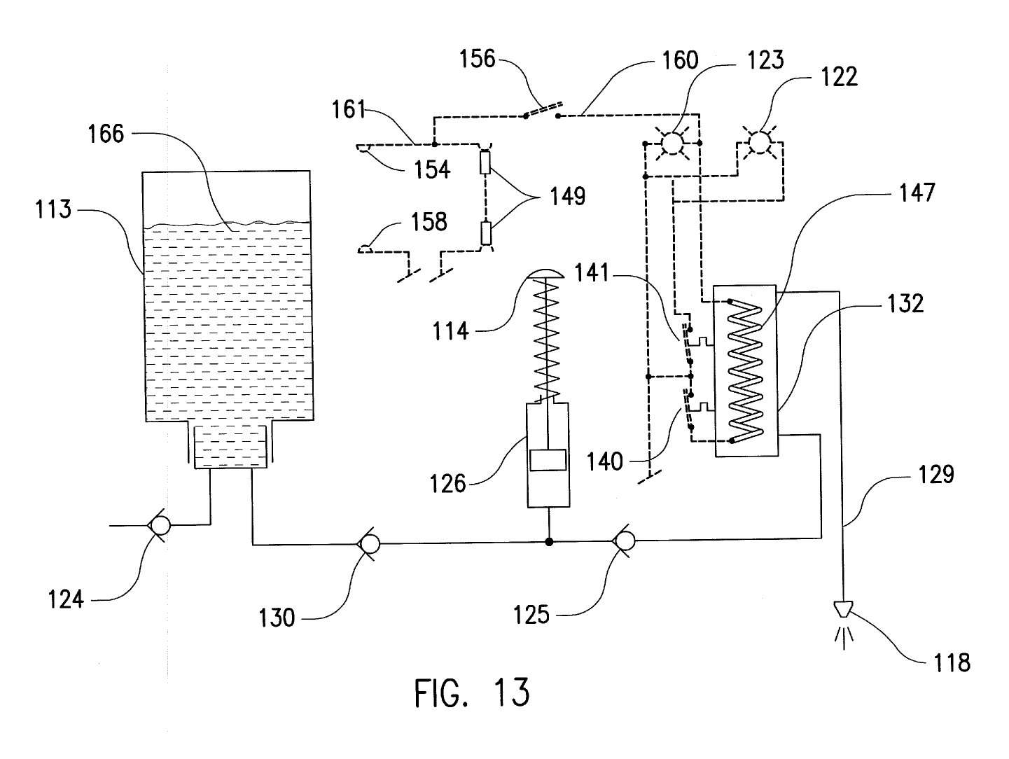

FIG. 13 is a schematic diagram that demonstrates the interaction between the electrical and hydraulic parts of the steam sprayer 100. When a user depresses the injector button 114, the water stored in the bottle 113 progresses through the exit check valve 125 and into the steam chamber 132, where it is heated in the steam chamber 132. The steam chamber 132 is heated to a predetermined temperature by the heating coil 147. Steam is produced, which progresses through the steam tube 129 and exits through the spray nozzle 118. The power thermostat 140 and the indicator thermostat 141 are closed, meaning the steam chamber 132 has reached a predetermined temperature to generate steam, but has not reached a higher predetermined temperature necessitating the reduction in temperature in the steam chamber 132. The ability of the steam chamber 132 to generate steam is shown by the illuminated ready light 122. The illuminated power light 123 shows the power switch 156 is closed and that the heating coil 147 is engaged to the batteries 146 over the power wire 160. A grounded contact 158 is engaged to the conductive parts of the steam sprayer 100 and serves as the second power line to ground.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention and are intended to be covered by the following claims.

What is claimed is:

1. A steam spraying device, comprising:
a handle;
a body comprising a right shell and a left shell having an interior void for receiving a container containing liquid;
a pump;
a steam generation chamber for converting the liquid to steam; and
a spray nozzle for dispensing the steam.

2. The steam spraying device of claim 1, further comprising a switch for activating the pump.

3. The steam spraying device of claim 1, further comprising a hood positioned around the spray nozzle.

4. The steam spraying device of claim 1, further comprising the handle having a hollow inner cavity and at least one battery positioned within the hollow inner cavity of the handle.

5. The steam spraying device of claim 1, further comprising a container mount having inner threads for receiving a correspondingly threaded container and engaging the container mount and the container in a selectively secured arrangement, wherein the container mount further includes a gasket disposed between the container and container mount.

6. The steam spraying device of claim 1, further comprising a power cable for supplying power to the steam spraying device.

7. The steam spraying device of claim 1, further comprising a ready light for indicating when steam has been generated by the steam spraying device.

8. A steam spraying device, comprising:
a handle having a hollow inner cavity;
a body comprising a right shell and a left shell that are selectively secured to each other forming an interior void for receiving a container containing liquid;
a pump disposed within the interior void of the right shell and the left shell;
a steam generation chamber for converting the liquid to steam;
a switch disposed on the handle for activating the pump; and
a spray nozzle for dispensing the steam.

9. The steam spraying device of claim 8, further comprising a hood positioned around the spray nozzle.

10. The steam spraying device of claim 8, further comprising at least one battery positioned within the hollow inner cavity of the handle.

11. The steam spraying device of claim 8, further comprising a container mount having inner threads for receiving a correspondingly threaded container and engaging the container mount and the container in a selectively secured arrangement, wherein the container mount further includes a gasket disposed between the container and container mount.

12. The steam spraying device of claim 8, further comprising a power cable for supplying power to the steam spraying device.

13. The steam spraying device of claim 8, further comprising a ready light for indicating when steam has been generated by the steam spraying device.

14. A steam spraying device, comprising:
a handle having a hollow inner cavity;
a body comprising a right shell and a left shell that are releasably engaged to each other forming an interior void;
a container mount disposed within the interior void for receiving a container of liquid that comprises a gasket and an aspirator valve, wherein the gasket prevents leakage from the container when engaged to the container mount and the aspirator valve permits air to pass into the container;
a pump disposed within the interior void of the right shell and the left shell;
a steam generation chamber for converting the liquid to steam;
a switch disposed on the handle for activating the pump; and
a spray nozzle for dispensing the steam.

15. The steam spraying device of claim 14, further comprising a hood positioned around the spray nozzle.

16. The steam spraying device of claim 14, wherein the at least one battery is at least one rechargeable battery positioned within the hollow inner cavity of the handle.

17. The steam spraying device of claim 14, wherein the container mount comprises inner threads for receiving a correspondingly threaded container and engaging the container mount and the container in a selectively secured arrangement.

18. The steam spraying device of claim 14, further comprising a power cable for supplying power to the steam spraying device.

19. The steam spraying device of claim 14, further comprising a power thermostat for regulating the temperature in the steam generation chamber.

20. The steam spraying device of claim 14, further comprising a power cable for supplying power to the steam spraying device.
